(19) United States
(12) Patent Application Publication
(10) Pub. No.: US 2006/0190960 A1
(43) Pub. Date: Aug. 24, 2006

(54) System and method for incorporating video analytics in a monitoring network

(76) Inventor: Geoffrey T. Barker, Bainbridge, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/353,877

(22) Filed: Feb. 14, 2006

Related U.S. Application Data
(60) Provisional application No. 60/652,894, filed on Feb. 14, 2005.

(51) Int. Cl. H04N 5/445; H04H 9/00; H04N 7/16; H04N 7/173; G06F 3/00; G06F 13/00; H04N 7/18

(52) U.S. Cl. 725/14; 725/80; 725/112; 725/46; 725/9

(57) ABSTRACT

A system and method for incorporating video analytics data in a monitoring network are provided. A processing server obtains video analytics device data from one or more monitoring devices. The processing server processes and stores the video analytics device data according to one or more unique identifiers. Utilizing decision logic, the processing server evaluates the video analytics data to generate one or more predictive assessments. Each predictive assessment can result in the initiation of actions or notification of authorized personnel based upon an event occurrence.

### CROSS-REFERENCE TO RELATED APPLICATION

This application claims the benefit of U.S. Provisional Application No. 60/652,894, entitled SYSTEM AND METHOD FOR INCORPORATING VIDEO ANALYTICS IN A MONITORING NETWORK, and filed on Feb. 14, 2005. U.S. Provisional Application No. 60/652,894 is incorporated by reference in its entirety.

### FIELD OF THE INVENTION

In general, the present invention relates to computer software, hardware and communication networks, and in particular, to a system and method for incorporating video analytics in a monitoring network.

### BACKGROUND

Generally described, monitoring systems are used to collect data from a number of monitoring devices within a monitored environment. Monitoring device data is used to identify event conditions. The data collected from monitoring devices is also used to evaluate event conditions and to prioritize event response once an event occurs. In the context of physical security, monitoring data generally documents the current or past security status of a given premises.

Although the traditional security monitoring system obtains information regarding the status of various aspects of a monitored premises, such as the status of physical devices or the presence or location of individuals, the outputs generated by traditional security monitoring network data are fundamentally reactive in nature. For example, when a security monitoring system obtains data from a motion sensor, the data output for the traditional security monitoring network is typically limited to a determination of whether or not motion occurred and whether the detected motion is authorized. Both of these outputs are reactive in nature. Similarly, if a security monitoring network obtains live video data, the data output for the traditional monitoring network will be a transmission of the incoming video data to a display terminal, or more reactive, the archival of the video data. Clearly, the traditional security monitoring network cannot predict when motion will be detected or what the contents of the video motion may be. Thus, most, if not all, monitoring networks, are designed for, and limited to, reactive data processing.

Video analytics software products such as those offered by ObjectVideo and Intelli-Vision apply video algorithms to a video data stream. The algorithms employed by the products are capable of detecting and identifying objects that are located within, or moving through, a video field of view. For example, current video analytics products can discriminate between an individual and an object such as a suitcase. (ObjectVideo white paper “Critical Asset Protection, Perimeter Monitoring and Threat Detection Using Automated Video Surveillance.”)
http://www.objectvideo.com/downloads/IVS_whitepaper.pdf

Video analytics software, or other forms of computer vision products are useful aids for threat assessment. For example, in a monitored environment such as an airport terminal, a video analytics software product could first detect an object in a field of view and then identify that object, for example, as a suitcase. The software might also be able to apply rules for the amount of time a particular object, such as a suitcase, may remain in one location without movement, and if such time is exceeded, trigger some time of alarm. In this way, a more serious security event might be avoided.

Unfortunately, despite the relative sophistication of computer vision technology, such as video analytics software, when considered in comparison to its predecessor—video motion detection, this technology is, in an of itself, insufficient to meet the current challenges of physical security. Video analytics produces discrete data resulting from the analysis of a video data stream or video field of view. Video analytics systems are generally not fully integrated within a monitoring network. If video analytics data produced by video analytics products could be incorporated into a monitoring system capable of assessing data produced by multiple monitoring devices/types the utility of the video analytics data would clearly be enhanced. Further, the video analytics data could be used within a networked monitoring system that was capable of generating threat assessments resulting from the processing of multiple data inputs according to device monitoring rules, its utility would be even further enhanced. There are a number of situations in which the processing of multiple data inputs to assess the likelihood of a target event in order to facilitate a preemptive, rather than a purely reactive, response is clearly beneficial. Thus, there is a need for a system and method for incorporating video analytics data in a monitoring network.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A system and method for incorporating video analytics data in a monitoring network are provided. A processing server obtains video analytics data associated with at least one video monitoring device. The processing server processes and stores the video analytics data according to one or more unique identifiers. Utilizing decision logic, the processing server evaluates the video analytics monitoring data to generate one or more threat assessments. Each assessment may prompt one or more programmatic responses such as the activation of one or more devices, alarm signals, generation of notification or notification sequences, or any number of combinations thereof.

In accordance with an aspect of the present invention, a system for processing video analytics data is provided. The system includes at least one video device used to collect video data, such as an analog or digital video camera, and at least one integrated, or separate, video algorithm used to detect and classify objects (for example, a human figure) located within collected video data. The system also includes a first processing server for obtaining the video analytics device data and processing the video analytics data according to at least one processing rule. The first processing server utilizes processing rules from the processing rules data store to perform a threat assessment and to generate at least one output or action.

In accordance with another aspect of the present invention, the system performs a threat assessment applying dynamic or programmatically applied processing rules to one or more “targets,” a detected, and/or classified, object or any isolated subset of collected video analytics data. In an actual embodiment, the processing rules applied to a target may relate to the location, number, type, identity, or any other measurable aspect of a target detected within a monitored premises. The first processing server utilizes processing rules from the processing rules data store to perform a threat assessment and to generate at least one output or action.

In accordance with a further aspect of the present invention, a system for processing video analytics data is provided. The system includes at least one information collection computing device for obtaining video analytics data from a number of monitoring devices. The video analytics data corresponds to at least one identifiable target. The system further includes a central processing server in communication with the at least one information collection computing device and operable to receive the video analytics data corresponding to at least one identifiable target. The system also includes a processing rules data store having processing rules corresponding to one or more identifiable targets. The central processing server obtains a processing rule corresponding to the at least one target, performs a predictive assessment of the video analytics data according to the processing rule, and generates at least one output corresponding to the predictive assessment.

In accordance with another aspect of the present invention, a method for incorporating video analytics data is provided. The method may be implemented in a monitoring device network having at least one video device collection device, a video analytics device (separated or integrated with the video device), and at least one non-video monitoring device (such as a motion sensor, thermal sensor, radio frequency identification (RFID) device, biometric scanning device, bar code reader, smart card reader, or any other data scanning or collection device), and a processing rules data store. The processing rules data store includes rules corresponding to the video analytics data and rules corresponding to the non-video monitoring device data. In accordance with the method, a processing system obtains video analytics data and applies at least one processing rule corresponding to the video analytics data from the processing rules data store. The processing system also obtains non-video monitoring device data (collected either sequentially or contemporaneously with the video analytics data) and applies at least one processing rule corresponding to the non-video monitoring device data. The processing system processes the video analytics data according to the at least one processing rule to and the non-video monitoring devices data and generates an output resulting from the processing of both sets of data.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a representative portion of the Internet;

FIG. 2 is a block diagram of a threat assessment system formed in accordance with the present invention;

FIG. 3 is a block diagram illustrative of a threat assessment system including a central processing server and one or more external data sources formed in accordance with the present invention;

FIG. 4 is a block diagram illustrative of an threat assessment system including a central server and two external data sources formed in accordance with an alternative embodiment of the present invention;

FIG. 5 is a block diagram of an illustrative architecture for a premises server formed in accordance with the present invention;

FIG. 6 is a block diagram of an illustrative architecture of a central processing server formed in accordance with the present invention; and

FIGS. 7A and 7B are flow diagrams illustrative of a threat assessment processing routine implemented by a premises or central processing server in accordance with the present invention.

### DETAILED DESCRIPTION

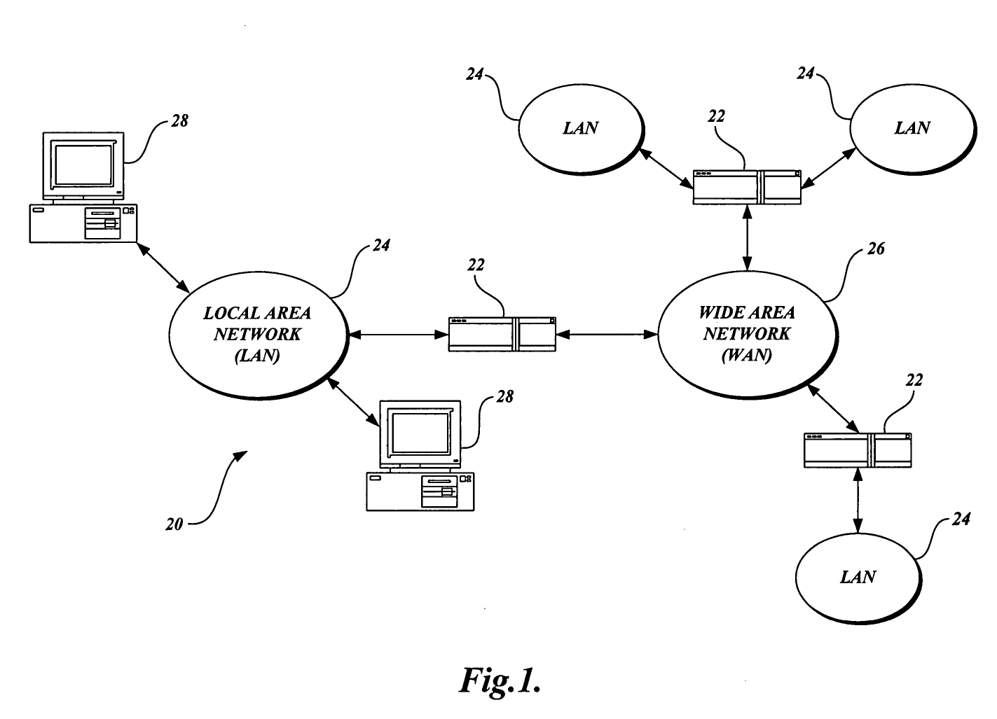

As described above, aspects of the present invention are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, where a plurality of local area networks (“LANs”) 24 and a wide area network (“WAN”) 26 are interconnected by routers 22. The routers 22 are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers 28 and other related electronic devices can be remotely connected to either the LANs 24 or the WAN 26 via a digital communications device, modem and temporary telephone, or a wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present invention could apply in any such interactive communication environments, however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a Web site elsewhere on the Internet. Each hyperlink is assigned a Uniform Resource Locator (“URL”) that provides the name of the linked document on a server connected to the Internet. Thus, whenever a hypertext document is retrieved from any Web server, the document is considered retrieved from the World Wide Web. Known to those skilled in the art, a Web server may also include facilities for storing and transmitting application programs, such as application programs written in the JAVA® programming language from Sun Microsystems, for execution on a remote computer. Likewise, a Web server may also include facilities for executing scripts and other application programs on the Web server itself.

A remote access user may retrieve hypertext documents from the World Wide Web via a Web browser program. A Web browser, such as Netscape's NAVIGATOR® or Microsoft's Internet Explorer, is a software application program for providing a user interface to the WWW. Upon request from the remote access user via the Web browser, the Web browser requests the desired hypertext document from the appropriate Web server using the URL for the document and the HyperText Transport Protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the Web server, such as JAVA applets, for execution on the client computer. Finally, the WWW browser may include optional software components, called plug-ins, that run specialized functionality within the browser.

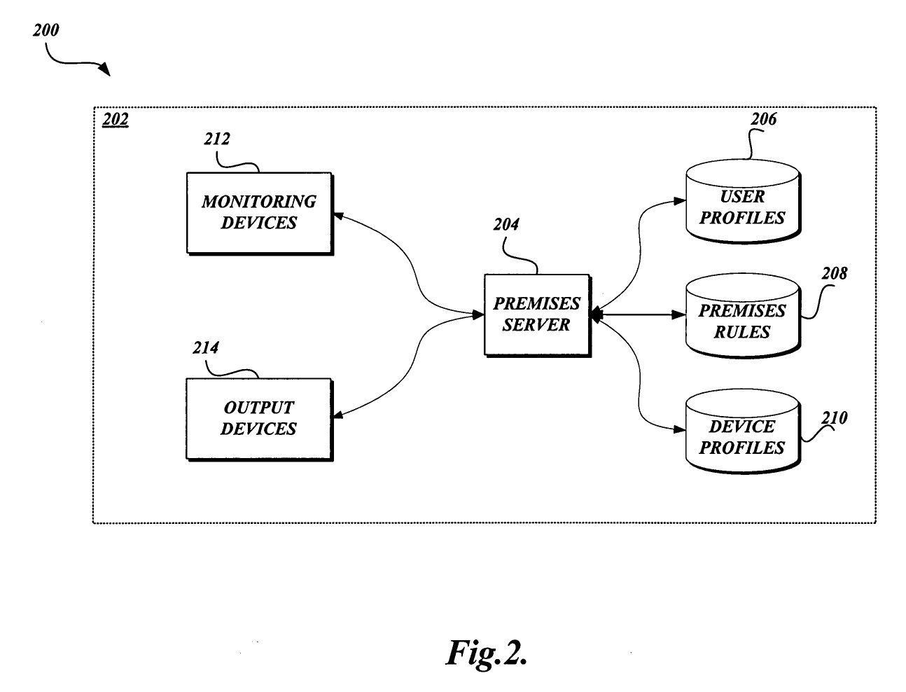

Referring now to FIG. 2, an actual embodiment of a threat assessment system 200 formed in accordance with the present invention will be described. The threat assessment system 200 facilitates the processing of multiple data inputs obtained from a number of monitoring devices located within one or more physical premises. The threat assessment system processes the video analytics data according to one or more processing rules, which can be system controlled or premises-specific. Based on an evaluation of the inputs and a corresponding rule, the threat assessment system 200 generates a threat assessment. Accordingly, the system 200 can implement a system response, including the request and processing of additional information. In an illustrative embodiment of the present invention, the threat assessment system 200 may be utilized to identify event conditions and/or to rank or prioritize the severity of an event condition.

With reference to FIG. 2, the threat assessment system 200 includes a premises server 204 assigned to a premises 202 or group of premises 202. In an illustrative embodiment of the present invention, the premises server 204 is located physically proximate to the premises 202. Alternately, the premises server 204 may be remote, or physically separated from the premises 202. Moreover, although a single premises server 204 is illustrated in FIG. 2, any number of computing devices may be utilized to implement the present invention.

In accordance with an illustrative embodiment of the present invention, the premises server 204 is in communication with a number of data sources for facilitating communication with various monitoring and output devices, for evaluating premises specific rules and/or for storing the inputted data for evaluation. More specifically, the premises server 204 is in communication with a premises rules database 206. The premises rules database 206 is operable to recall one or more premises specific rules for evaluating the video analytics data. As will be explained in further detail below, premises rules database 206 can include programmatic and declarative rules for utilization by processing systems, including but not limited to individual automata, neural networks, support vector machines and any additional learning systems. The premises server 204 is further in communication with a device profiles database 208 that includes information operable to control and interpret communications from the various monitoring and output devices connected to the premises server 204. One skilled in the relevant art will appreciate that various control methods may be utilized within the present invention to control the monitoring and output devices and obtain corresponding information. Further, one skilled in the relevant art will appreciate that the premises rules database 206 and the device profiles database 208 may be physically remote from the premises server 204 and may be implemented as part of a distributed database network.

As also illustrated in FIG. 2, the premises server 204 can communicate with one or more monitoring devices 210 via a network connection. A more detailed description of a network for communicating with monitoring devices, including the use of one or more device servers, is found in co-pending U.S. patent application Ser. No. 10/117,552, entitled SYSTEM AND METHOD FOR MANAGING A DEVICE NETWORK and filed on Apr. 4, 2002, the disclosure of which is hereby incorporated by reference. In an illustrative embodiment, the monitoring devices 210 may include video cameras, computer vision hardware/and or software devices, object identification/and or tracking software, and biometric identification devices. Still further the monitoring devices 210 may include access control devices such as card readers, motion sensors, thermal sensing devices and the like. The monitoring devices 210 can also be integrated with other existing information systems, such access control systems, traffic control systems, inventory control systems, passenger reservation systems, point-of-sale (“POS”) systems, and the like. It will be apparent to one skilled in the relevant art that additional or alternative monitoring devices 210 corresponding to a specific monitoring function may be practiced with the present invention.

The premises server 204 also communicates with one or more output devices 212. In an illustrative embodiment, the output devices 212 can include alarm signaling devices, floodlights, audio projection devices, or any of a variety of state-changing wired or wireless devices. As will be readily understood by one skilled in the art, the type of output device is associated primarily with the type of action the threat assessment system 200 generates. Accordingly, additional or alternative output devices 212 are considered to be within the scope of the present invention. In accordance with the present invention, the monitoring devices 210 and the output devices 212 can be linked together in a computer network environment in which multiple premises servers 202 work in parallel, sharing data and processes. Moreover, additional premises servers 202, monitoring devices 210, and output devices 212 may be joined modularly to provide extensibility to the system 200.

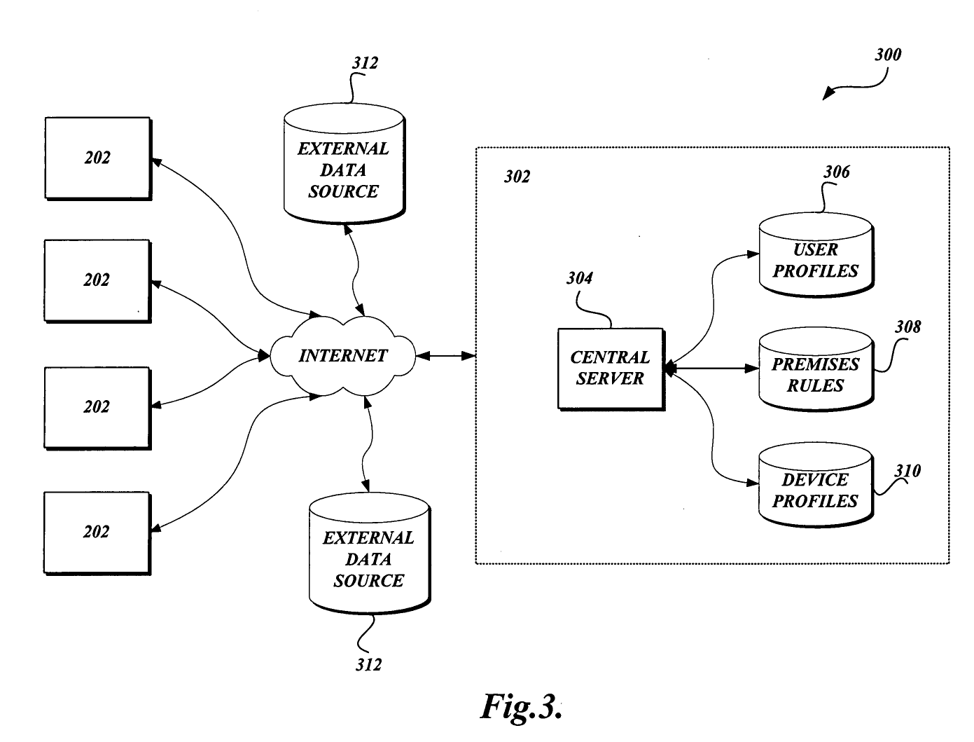

Turning now to FIG. 3, an expanded embodiment of the present invention will be explained. In accordance with this embodiment, a threat assessment system 300 includes a number of premises 202 and premises servers 204 that operate as described with respect to FIG. 2. Each of these premises 202 communicates to a central processing facility 302 that includes at least one central processing server 304. In an illustrative embodiment of the present invention, the individual premises 202 can communicate via global communication network such as the Internet 20, or alternatively via private communication networks and/or communication lines. Similar to the premises server 204, the central processing server 304 is in communication with a number of data sources to facilitate processing incoming monitoring device data from the premises 202 and communicating with various monitoring devices within each individual premises 202. More specifically, the central server 304 includes a premises rules database 306, and a device profiles database 308. In an illustrative embodiment of the present invention, the central processing server 304 data sources have similar functions to the premises rules database 206 and device profile database 208 (FIG. 2) and operable to add a second data processing layer to the threat assessment system 300. The premises rules database 306 is operable to provide rules for processing premises monitoring device-specific data. In an illustrative embodiment of the present invention, the premises rules database may maintain individually customized rules for each premises 202 on the system 300 or a set of rules applicable to each premises. Finally, the device profiles database 308 is operable to interpret and/or control the various monitoring devices from each premises 202. Similar to the premises databases, the central server databases may be physically proximate to the central server 304, may be remote or physically separate from the central server 304 and implemented as part of a distributed database system.

The threat assessment system 300 can also include one or more external data sources 310, operable to supply additional information to the central processing server 304. In an illustrative embodiment of the present invention, the external data sources 310 can include law enforcement databases, governmental databases, international databases, internal company databases, third-party commercial databases, and the like.

In accordance with this embodiment of the present invention, the premises server 204 can obtain and process monitoring device data. As part of the processing, the premises server 204 can transmit the monitoring device data and any processing results to the central processing server 204. The central server can obtain the data from the individual premises 202, process it according to its premises rules to generate an threat assessment. Additionally, the central processing server 304 may also obtain additional information, such as from the external data sources 310, as part of the data processing step, or as a result of a preliminary data processing. For example, the central server 304 could obtain an threat assessment and monitoring device data from an individual premises server 204, and then request additional information from an external data source 310, such as an FBI record database. In conjunction with its processing rules and the additional data, the central processing server 304 may generate one or more threat assessments and implement any number of actions. Accordingly, an threat assessment system 300 can implement multiple layers for processing.

Although a single central processing server 304 is illustrated in FIG. 3, one skilled in the relevant art will appreciate that any number of central processing servers 304 may be implemented to process data from premises servers 204. Moreover, multiple central processing servers 304 may be utilized within an threat assessment system 300 to generate any number of processing layers. For example, a second central processing server 304 may be utilized to process data from the first central processing server 304.

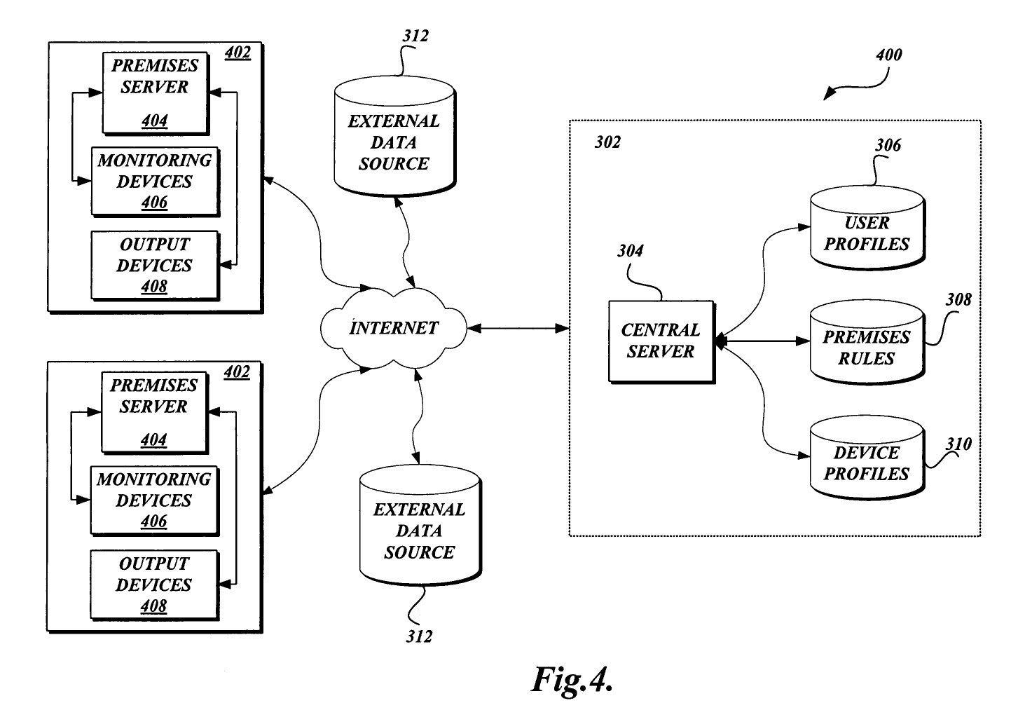

With reference now to FIG. 4, an alternative embodiment for an threat assessment system 400 will be described. In accordance with this embodiment, the threat assessment system 400 includes a number of premises 402 that include a premises server 404, monitoring devices 406, and output devices 408. However, the premises server 404 does not include additional data sources, such as a premises rule database or device profile database, to process the monitoring device data. Instead, all of the monitoring device and output device data is transferred to a central server 304 which evaluates monitoring device data according to a premises rule database 306, and a device profiles database 308, described above. The central server 304 can obtain additional external data from an external data source 310. However, one skilled in the art will appreciate that the central server 304 can then transfer the data to an additional layer (not shown) to implement additional processing layers.

In accordance with this embodiment of the present invention, the individual premises 402 no longer have the ability to process the monitoring device data and transfer it to an external source. Additionally, in another embodiment of the present invention, the premises server 402 may also be omitted such that the monitoring devices 406 transmit data directly to the central server 304. Still further, the threat assessment system 400 may be further modified to include a combination of premises 202 (FIG. 2) having a premises server 204 and premises 402 communicate unprocessed monitoring device data to a central processing server 304. All such embodiments are considered to be within the scope of the present invention.

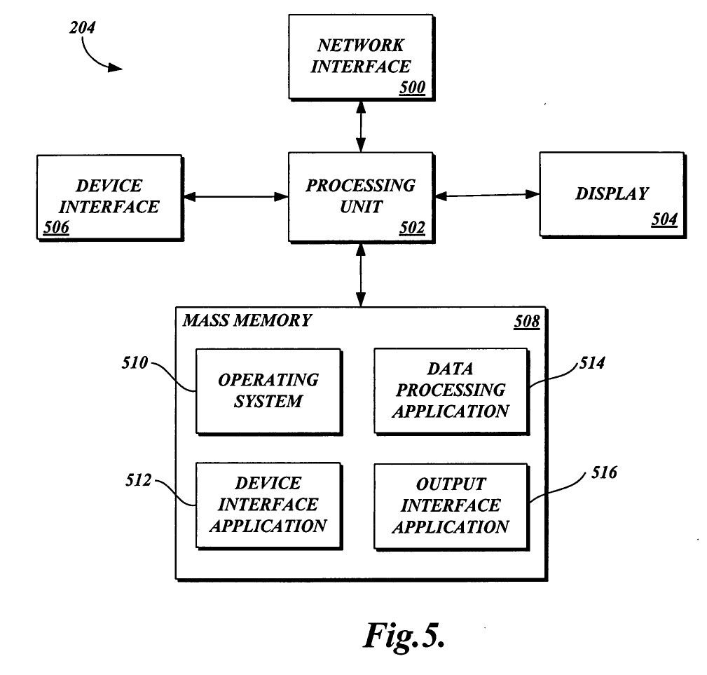

FIG. 5 is a block diagram depicting an illustrative architecture for a premises server 204 (FIG. 2). Those of ordinary skill in the art will appreciate that the premises server 204 includes many more components then those shown in FIG. 5. However, it is not necessary that all of these generally conventional components be shown in order to disclose an illustrative embodiment for practicing the present invention. As shown in FIG. 5, the premises server 204 includes a network interface 502 for connecting directly to a LAN or a WAN, or for connecting remotely to a LAN or WAN. Those of ordinary skill in the art will appreciate that the network includes the necessary circuitry for such a connection, and is also constructed for use with the TCP/IP protocol, the particular network configuration of the LAN or WAN it is connecting to, and a particular type of coupling medium. The premises server 204 may also be equipped with a modem for connecting to the Internet through a point-to-point protocol (“PPP”) connection or a serial-line Internet protocol (“SLIP”) connection as known to those skilled in the art.

The premises server 204 also includes a processing unit 504, an optional display 506, an input/output (I/O) interface 508 and a mass memory 510, all connected via a communication bus, or other communication device. The I/O interface 508 includes hardware and software components that facilitate interaction with a variety of the monitoring devices via a variety of communication protocols including TCP/IP, X10, digital I/O, RS-232, RS-485 and the like. Additionally, the I/O interface 44 facilitates communication via a variety of communication mediums including telephone landlines, wireless networks (including cellular, digital and radio networks), cable networks and the like. In an actual embodiment of the present invention, the I/O interface is implemented as a layer between the server hardware and software applications utilized to control the individual monitoring devices. It will be understood by one skilled in the relevant art that alternative interface configurations may be practiced with the present invention.

The mass memory 510 generally comprises a RAM, ROM, and a permanent mass storage device, such as a hard disk drive, tape drive, optical drive, floppy disk drive, or combination thereof. The mass memory 510 stores an operating system 512 for controlling the operation of the premises server. It will be appreciated that this component may comprise a general-purpose server operating system as is known to those skilled in the art, such as UNIX, LINUX™, or Microsoft WINDOWS NT®. The memory also includes a WWW browser 50, such as Netscape's NAVIGATOR® or Microsoft's Internet Explorer browsers, for accessing the WWW.

The mass memory 510 also stores program code and data for interfacing with various premises monitoring devices, for processing the monitoring device data and for transmitting the processed data. More specifically, the mass memory 510 stores a device interface application 514 in accordance with the present invention for obtaining monitoring device data from a variety of devices and for manipulating the data for processing. The device interface application 514 comprises computer-executable instructions which, when executed by the premises server 204 obtains and transmits device data as will be explained below in greater detail. The mass memory 510 also stores a data processing application 512 for processing monitoring device data in accordance with rules maintained within the rules database 208. The mass memory 510 further stores an output interface application program 518 for transmitting processed device data to one or more external system components. The operation of the data transmittal application 516 will be described in greater detail below. It will be appreciated that these components may be stored on a computer-readable medium and loaded into the memory of the premises server using a drive mechanism associated with the computer-readable medium, such as a floppy, CD-ROM, DVD-ROM drive, or network drive.

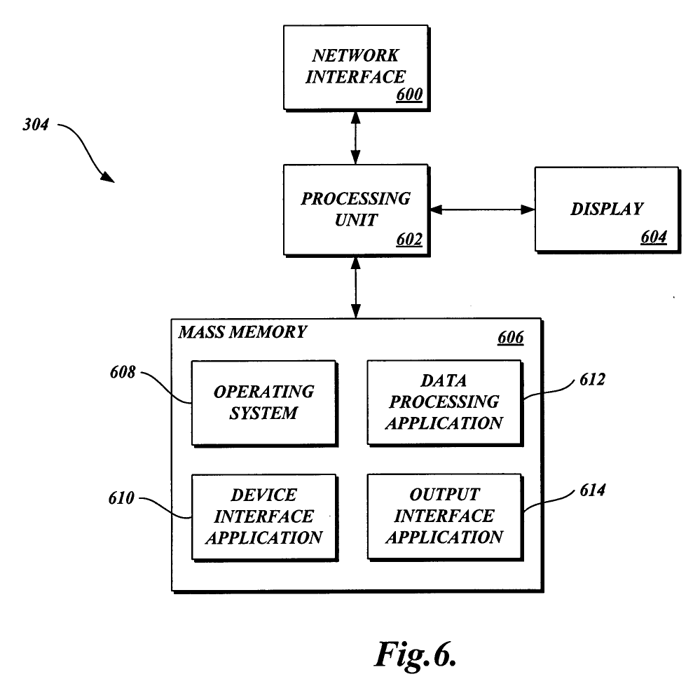

FIG. 6 is a block diagram depicting an illustrative architecture for a central server 304 (FIG. 3). Those of ordinary skill in the art will appreciate that the central server 304 includes many more components then those shown in FIG. 6. However, it is not necessary that all of these generally conventional components be shown in order to disclose an illustrative embodiment for practicing the present invention.

As shown in FIG. 6, the central server 304 includes a network interface 600 for connecting directly to a LAN or a WAN, or for connecting remotely to a LAN or WAN. Those of ordinary skill in the art will appreciate that the network interface includes the necessary circuitry for such a connection, and is also constructed for use with the TCP/IP protocol, the particular network configuration of the LAN or WAN it is connecting to, and a particular type of coupling medium. The central server 304 may also be equipped with a modem for connecting to the Internet 20.

The central server 304 also includes a processing unit 602, an optional display 604 and a mass memory 606, all connected via a communication bus, or other communication device. The mass memory 606 generally comprises a RAM, ROM, and a permanent mass storage device, such as a hard disk drive, tape drive, optical drive, floppy disk drive, or combination thereof. The mass memory 606 stores an operating system 608 for controlling the operation of the central server. It will be appreciated that this component may comprise a general-purpose server operating system.

The mass memory 606 also stores program code and data for interfacing with the premises devices, for processing the device data and for interfacing with various authorized users. More specifically, the mass memory 606 stores a premises interface application 610 in accordance with the present invention for obtaining data from a variety of monitoring devices and for communicating with the premises server. The premises interface application 610 comprises computer-executable instructions, which, when executed by the central server 304, interface with the premises server 204 as will be explained below in greater detail. The mass memory 606 also stores a data processing application 612 for processing monitoring device data in accordance with rules maintained within the premises rules database 306. The operation of the data processing application 612 will be described in greater detail below. The mass memory 606 further stores an output interface application 614 for outputting the processed monitoring device data to a variety of authorized users or additional central processing servers 304 in accordance with the present invention. The operation of the output interface application 614 will be described in greater detail below. It will be appreciated that these components may be stored on a computer-readable medium and loaded into the memory of the central server using a drive mechanism associated with the computer-readable medium.

Generally described, the present invention facilitates the collection and processing of a variety of premises information to generate one or more threat assessments of potential future activity. The system of the present invention obtains monitoring data from any one of a variety of monitoring devices 212. In an actual embodiment of the present invention, the monitoring device data is video analytics data produced by monitoring systems that detect, identify, classify, and track physical objects or entities.

In an illustrative embodiment of the present invention, the video analytics data is obtained by the monitoring devices 212 on the premises server 204 and processed according to some form of decision logic. In an actual embodiment of the present invention, the premises server maintains databases 208 having logic rules for video analytics data. Moreover, because the video analytics data is potentially applicable to more than one authorized user, multiple rules may be applied to the same monitoring device data. Alternatively, the video analytics data may be processed according to a weighted decision logic, such as a neural network, that does not utilize fixed decision logic. Still further, as illustrated in FIGS. 3 and 4, some or all of the video analytics data may be processed by the central server 304 according to different processing layer logic rules maintained in the premises rules database 306.

Based on the evaluation of the decision logic, the premises server 204 can generate an threat assessment corresponding to the outcome of the threat assessment (a determined likelihood of an event condition). In an illustrative embodiment of the present invention, the threat assessment may be in the form of a numerical indicator that has one or more actions associated with it. For example, in an airline security monitoring embodiment, a numerical threat assessment can cause law enforcement authorities to implement a pre-defined set of actions. In another embodiment of the present invention, the threat assessment can be in the form of a set of customized actions initiated by the monitoring system. With reference to the airline security example, a customized threat assessment can be in the form of a transfer of data to an individual, or group of individuals, that are determined to be relevant to the particular set of monitoring device data. Moreover, in yet another embodiment of the present invention, a threat assessment system 200, 300 or 400 may utilize a combination of pre-determined numerical identifiers and customized actions.

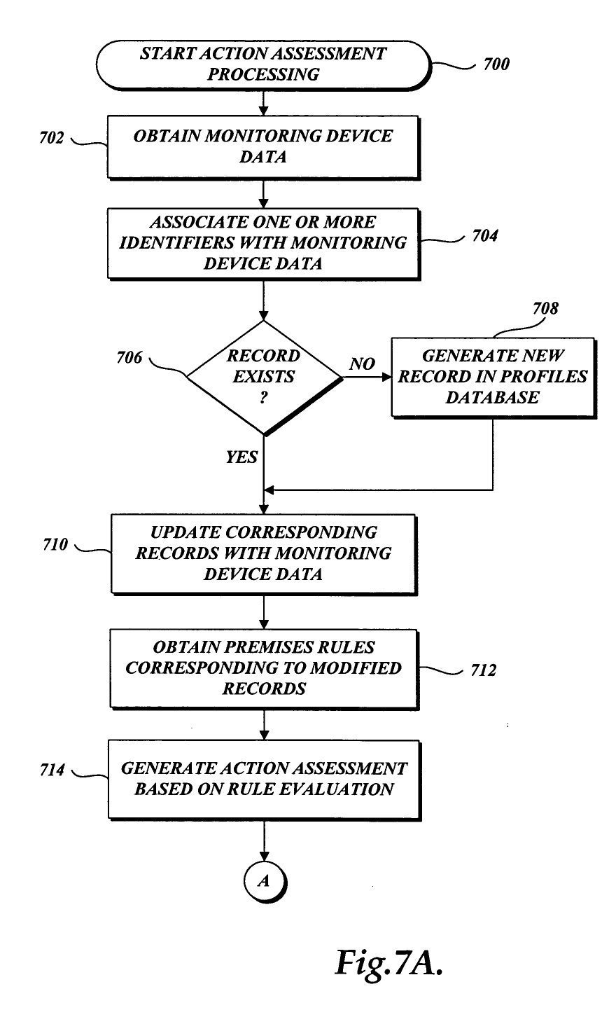

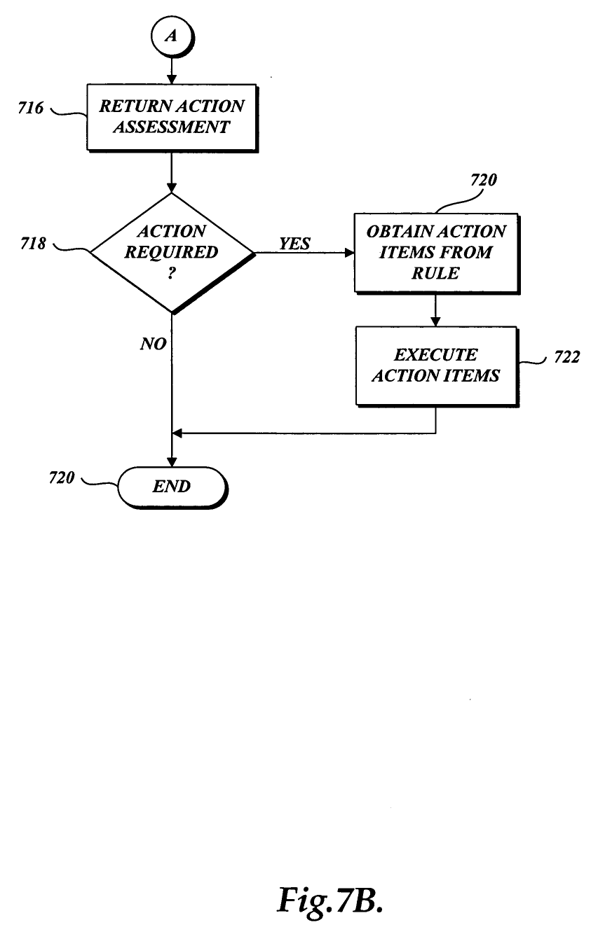

With reference now to FIGS. 7A and 7B, a routine 700 for processing an threat assessment implemented by a premises server 204 in accordance with the present invention will be described. Although routine 700 is described in relation to a premises server 204, the routine 700 may be implemented by the central server 304, or other similarly configured computing device. With reference to FIG. 7A, at block 702, video analytics data is obtained from one or more video analytics devices. Additionally, the video analytics data can also include additional information that facilitates the origin of the monitoring device data (e.g., a device identifier) and any other information describing a parameter associated with the collection of the data (e.g., a time stamp).

At block 704, the data processing application 716 associates one or more identifiers corresponding to the video analytics data. In an illustrative embodiment of the present invention, the unique identifiers can include any identifiable data that can be used to associate the video analytics data with a location, individual, or identifiable object. One skilled in the relevant art will appreciate that the video analytics data can generate multiple unique identifiers.

At decision block 706, a test is conducted to determine whether a rule exists in the device rules database 308 for video analytics device. If no rule or record exists in the device rules database 308, at block 708, the data processing application 512 generates a new record in the device rules database 308. In an illustrative embodiment of the present invention, each premises 202 may maintain an independent premises rules database 206 that is not dependent on any other premises. Additionally, each individual premises 202 may be configured to allow the various premises 202 on the system to share data by synchronizing the database records on a periodic basis. Alternatively, the premises rules database 206 may also be configured to be mirrored to other selected databases on a more immediate basis. Similarly, one or more premises 202 may be configured to allow for the sharing of the premises rules data by the implementation of a distributed database network.

Once a corresponding record has been retried or create (block 708), at block 710, the data processing application 512, updates the corresponding record with the monitoring device data. In an illustrative embodiment of the present invention, rules-based logic may be implemented in a declarative manner to provide more opportunities for system administrators, or other authorized personnel, to customize a threat assessment for a particular evaluation of inputs and/or to modify the number of combination of inputs supported by the data processing application 512. In an illustrative embodiment of the present invention, each premises rules database 206 may be populated with a pre-defined set of processing rules. Accordingly, to modify the rules according to preferences set by each premises, the rules could be generated, and therefore modified, according to a declarative user interface. The declarative user interface allows for the modification of the processing rules as the video analytics data is processed.

In yet another embodiment of the present invention, the data processing application 512 may utilize a neural network, support vector machine, or other learning system, to establish a threat assessment based upon values for a given set of inputs. One skilled in the relevant art will appreciate that a learning system includes a randomly selected weighting scale for a given number of inputs. By utilizing a number of training data sets in which an output is known for a given set of inputs, the learning system could be trained to adjust the weight values for the various inputs to generate an appropriate output, or set of outputs. In accordance with this embodiment, the data processing application 512 would utilize the learning system to generate an output based on values for any number of data inputs and combination of the inputs. Moreover, the premises rules database 208 could include different weighing schema that would allow for modification of the learning system outputs for different factual scenarios. Likewise, in one embodiment, each premises would have the capability to modify the weights for each input, to customize the processing of the data.

At block 712, the data processing application 512 obtains premises rules corresponding to the modified records and an action assessment is generated based on the rule evaluation at block 714. In an alternative embodiment to block 714, the monitoring device data may not be automatically processed as it is received. Instead, the data processing application 512 may delay the processing of data for a given time period to allow the collection of multiple information pieces and reduce redundant data processing. Additionally, the data processing application 512 may pre-process the monitoring device data prior to applying a processing rule. For example, the data processing application may utilize finite automata to search for specific types of data to process. The data processing application 512 may program finite automata to search for a particular individual or object. Alternatively, the data processing application 512 may filter monitoring device data according to its source to prioritize processing from different sources. Accordingly, routine 700 can be modified to incorporate the different embodiments.

Turning now to FIG. 7B, at block 716, the data processing application can return the threat assessment. In an illustrative embodiment of the present invention, the output interface application 516 can generate log files of the threat assessment and/or transmit the results of the processing to any number of authorized recipients. At decision block 718, a test is conducted to determine whether additional action items are required. If additional action items are required, at block 720, the data processing application 512 obtains the action items from the premises rules database 206. At block 722, the action items are initiated. In an illustrative embodiment of the present invention, the data processing application may obtain control information from the device profiles database 210 and utilize the output interface application 518 to generate the corresponding protocols to the output devices 214. Additionally, or alternatively, the output interface application 516 may transmit a request to another layer of processing, such as central processing server 304 (FIG. 3) to request that additional data processing take place. Upon the execution of the action items, or if no action items exist, the routine 700 terminates at block 724.

The systems and routines of the present invention may be incorporated in a number of monitoring environments. In one aspect, the present invention may be configured as an airport security threat assessment system to monitor for and preempt known security risks. In this embodiment, monitoring device data may be obtained from such disparate sources as security check points, passenger reservation systems, video cameras, biometric identification devices, RFID devices, motion sensors, etc. in addition to video analytics software devices in order to perform preemptive threat assessment for an airport. In an illustrative example, this type of integrated monitoring system for the assessment of airport security threats could assign rules for locations in which an object such as a suitcase can not be left for longer than a specified time period, before a responsive action is generated. Alternatively, rules for a suitcase left in an airport location could be linked to the time of day instead of, or in addition to the location, or amount of time the suitcase remains in a given location. Still further, the rules governing responsive action to a suitcase left in an airport could be processed according to a threat level applicable to the airport at the time.

While illustrative embodiments have been illustrated and described, it will be appreciated that various changes can be made therein without departing from the spirit and scope of the invention.

1. A computer-readable medium having computer-executable components for processing video analytics data comprising:
a video analytics components for detecting and classifying objects located within collected video data from a video monitoring device; and
a data processing component for obtaining the video analytics device data and processing the video analytics data according to at least one processing rule, wherein data processing component utilizes processing rules from the processing rules data store to perform a threat assessment and to generate at least one output or action.

2. The computer-readable medium as recited in claim 1, wherein the at least one video device data corresponds to information from an analog or digital video camera.

3. The computer-readable medium as recited in claim 1 further comprising an output component for generating an output corresponding to the threat assessment.

4. The computer-readable medium as recited in claim 3, wherein the output corresponding to the generation of an alarm signal.

5. The computer-readable medium as recited in claim 3, wherein the output corresponding to an activation of one or more devices.

6. The computer-readable medium as recited in claim 3, wherein the output corresponding to the generation of notification or notification sequences.

7. A system for processing video analytics data comprising:
at least one information collection computing device for obtaining video analytics data from a number of monitoring devices, wherein the video analytics data corresponds to at least one identifiable target;
a central processing server in communication with the at least one information collection computing device and operable to receive the video analytics data corresponding to at least one identifiable target;
a processing rules data store having processing rules corresponding to one or more identifiable targets;
wherein the central processing server obtains a processing rule corresponding to the at least one target, performs a predictive assessment of the video analytics data according to the processing rule, and generates at least one output corresponding to the predictive assessment.

8. In a monitoring device network having at least one video device collection device, a video analytics device and a processing rules data store, wherein the processing rules data store includes rules corresponding to the video analytics data and rules corresponding to the non-video monitoring device data, a method for processing video analytics data comprising:
obtaining video analytics data;
applying at least one processing rule corresponding to the video analytics data from the processing rules data store;
obtaining non-video monitoring device data;
applying at least one processing rule corresponding to the non-video monitoring device data;
processing the video analytics data according to the at least one processing rule to and the non-video monitoring devices data;
generating an output resulting from the processing of both sets of data.

9. The method as recited in claim 8, wherein the non-video monitoring device is selected from a group consisting of a motion sensor, thermal sensor, radio frequency identification device, biometric scanning device, bar code reader, smart card reader, or any other data scanning and collection device.

10. The method as recited in claim 8, wherein obtaining non-video monitoring device data includes sequentially obtaining the non-video monitoring device data.
